(19) United States
(12) Patent Application Publication
(10) Pub. No.: US 2008/0311939 A1
(43) Pub. Date: Dec. 18, 2008

(54) Acknowledgment aided space domain user scheduling for multi-user mimo

(75) Inventors: Klaus Hugl, Helsinki (FI); Marko Lampinen, Oulu (FI); Cassio Barboza Ribeiro, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/214,476

(22) Filed: Jun. 18, 2008

Related U.S. Application Data
(60) Provisional application No. 60/936,060, filed on Jun. 18, 2007.

(51) Int. Cl. H04B 7/00

(52) U.S. Cl. 455/507

(57) ABSTRACT

An apparatus includes a modulator configured to modulate a plurality of data sequences, where individual ones of the plurality of data sequences correspond to individual ones of a plurality of user equipment; a transmitter configured for operation with a plurality of antennas and further configured to simultaneously transmit the modulated data sequences to the plurality of user equipment; and a receiver configured to receive one of an acknowledgment or a non-acknowledgment indication from individual ones of the plurality of user equipment indicating success or failure, respectively, of an individual one of the user equipment correctly receiving a corresponding transmitted data sequence. The apparatus additionally includes a controller that is configured to respond to a predetermined number of non-acknowledgment indications being received from a particular one of the user equipment, for a particular one of the transmitted data sequences, to retransmit the corresponding data sequence only to the particular user equipment. Corresponding methods and computer programs are also disclosed.

### PRIORITY CLAIM

This patent application claims priority from U.S. Provisional Patent Application No.: 60/936,060, filed Jun. 18, 2007, the disclosure of which is incorporated by reference herein in its entirety.

### TECHNICAL FIELD

This invention relates generally to multiple-input, multiple-output transmission and reception and, more specifically, relates to acknowledgment-aided space domain user scheduling in a multiuser system.

### BACKGROUND

Multiple-input, multiple-output (MIMO) transmission and reception are techniques being used to improve the transmission and reception between elements in a wireless network. In a system that employs MIMO, typically multiple antennas are used by the transmitter and receiver. MIMO can be employed in a single user form, such as where all transmitted signals on the transmitter are used to transmit information from the transmitter to a single receiver. MIMO can also be employed in a multi-user form, such as where information corresponding to a number of receivers is transmitted to the receivers.

Multi-user MIMO (MU-MIMO) in the downlink (DL) used in third generation partnership project (3GPP) long-term evolution (LTE) frequency division duplex (FDD) is expected to be based on linear precoding at the subcarrier level. The precoding matrix, which encodes a signal targeted to different users, may be unitary or non-unitary. In the non-unitary precoding case, one proposed scheme is the so-called zero-forcing MU-MIMO. In general, the user equipment (UE), such as a mobile phone, needs to report channel state information and a channel quality estimate (e.g., channel quality indicator (CQI) information) to the Node B (e.g., an access point providing radio frequency communications with the UE). A problem is that the CQI information may not be easily available due to the transmitter scheduling occurring later in time. Note that the scheduling decision may affect the CQI level itself.

Hybrid automatic repeat request (HARQ) protocol can be efficiently used on the physical layer to increase the link performance and decrease the impact of CQI information error. The transmitter can retransmit the failed packets based on the feedback from the receivers.

### SUMMARY

The foregoing and other problems are overcome, and other advantages are realized, in accordance with the exemplary embodiments of this invention.

In accordance with a first aspect thereof the exemplary embodiments provide a method that includes modulating a plurality of data sequences, where the plurality of data sequences correspond to a plurality of user equipment; transmitting, using a plurality of antennas, the modulated data sequences to the plurality of user equipment and, in response to a predetermined number of non-acknowledgment indications being received from a particular one of the user equipment, retransmitting using the plurality of antennas a non-acknowledged data sequence corresponding only to the particular user equipment.

In accordance with another aspect thereof the exemplary embodiments provide an apparatus that includes a modulator configured to modulate a plurality of data sequences, where individual ones of the plurality of data sequences correspond to individual ones of a plurality of user equipment, a transmitter configured for operation with a plurality of antennas and further configured to simultaneously transmit the modulated data sequences to the plurality of user equipment and a receiver configured to receive one of an acknowledgment or a non-acknowledgment indication from individual ones of the plurality of user equipment indicating success or failure, respectively, of an individual one of the user equipment correctly receiving a corresponding transmitted data sequence. The apparatus additionally includes a controller that is configured to respond to a predetermined number of non-acknowledgment indications being received from a particular one of the user equipment, for a particular one of the transmitted data sequences, to retransmit the corresponding data sequence only to the particular user equipment.

In accordance with another aspect thereof the exemplary embodiments provide a computer-readable medium having program instructions tangibly embodied thereon, where execution of the program instructions result in operations that include modulating a plurality of data sequences, where the plurality of data sequences correspond to a plurality of user equipment; transmitting, using a plurality of antennas, the modulated data sequences to the plurality of user equipment and, in response to a predetermined number of non-acknowledgment indications being received from a particular one of the user equipment, retransmitting using the plurality of antennas a non-acknowledged data sequence corresponding only to the particular user equipment.

In accordance with still another aspect thereof the exemplary embodiments provide an apparatus that includes means for modulating a plurality of data sequences, where the plurality of data sequences correspond to a plurality of user equipment; means for transmitting in a multi-user multiple input/multiple output manner the modulated data sequences to the plurality of user equipment and means for retransmitting in the multi-user multiple input/multiple output manner a corresponding one of the data sequences to a particular user equipment from which a non-acknowledgment indication is received. The retransmitting means is configured to respond to a predetermined number of non-acknowledgment indications being received from a particular one of the user equipment for retransmitting in a single stream, single user manner a non-acknowledged corresponding one of the data sequences only to the particular user equipment. The predetermined number of non-acknowledgment indications is less than a maximum number, and if the maximum number of non-acknowledgment indications is received the retransmitting means terminates retransmission of the non-acknowledged corresponding one of the data sequences.

In accordance with yet another aspect thereof the exemplary embodiments provide an apparatus that includes a modulator configured to modulate a plurality of data sequences, where the plurality of data sequences correspond to a plurality of user equipment; and a transmitter configured with a controller to transmit in a multi-user multiple input/multiple output manner the modulated data sequences to the plurality of user equipment. The transmitter is further configured with the controller to retransmit in the multi-user multiple input/multiple output manner a corresponding one of the data sequences to a particular user equipment from which a non-acknowledgment indication is received. The controller is configured to respond to a predetermined number of non-acknowledgment indications being received from a particular one of the user equipment to operate said transmitter to retransmit in a single stream, single user manner a non-acknowledged corresponding one of the data sequences only to the particular user equipment.

### BRIEF DESCRIPTION OF THE DRAWINGS

The attached Drawing Figures include the following:

FIG. 1 is a simplified diagram of a wireless network suitable for implementing exemplary embodiments of the disclosed invention.

FIG. 2 is another representation of the wireless network shown in FIG. 1.

FIG. 3 is a flowchart of an exemplary method performed on user equipment to provide for an acknowledgment arrangement for multi-user MIMO.

FIG. 4 is a flowchart of an exemplary method performed on a base station to provide for an acknowledgment arrangement for multi-user MIMO.

FIG. 5 is an exemplary diagram of potential acknowledgment operation for multi-user MIMO.

### DETAILED DESCRIPTION OF EXEMPLARY EMBODIMENTS

Using the HARQ protocol a transmitter can retransmit failed packets (e.g., as part of a data sequence) based on the feedback from the receivers. Since the transmitter makes a decision as to how many users to transmit to in the space domain, the transmitter can increase the reliability of the retransmission of a single user by restricting the number of the spatially scheduled users.

As stated above, a problem is that the CQI should reflect the propagation channel quality appearing during the actual multi-user transmission. Since this information might not be easily available, the expected CQI error may be large. It may be better to feed back the conventional single user, single stream (SUSS) CQI, although this does not lessen, and may in fact increase the CQI error. Fortunately, enhanced HARQ retransmissions can be used to compensate the error.

For instance, in an exemplary embodiment herein a multi-user MIMO UE feeds back a channel quality estimate, such as a conventional, single-user CQI. The channel quality estimate corresponds to a case where a single beam is transmitted from transmit antennas to receive antennas. Thus, the channel quality estimate is a single-user CQI for conventional beamforming-based transmit diversity. Having the single-user CQI as feedback for MU-MIMO operation provides at least the advantage of simplicity as compared to more complex CQI calculation methods that attempt to take the multi-user interference into account. One exemplary method calculates an average CQI assuming that all user combinations would be equally likely. Reference may be made to 3GPP Technical Document RI-072287, “Channel Quality Indicator (CQI) Reporting for LTE MU-MIMO” (May 2007).

In an exemplary embodiment, the Node B scales down the reported single-user channel quality estimate, as the Node B may target to a more conservative (e.g., reduced in absolute value) channel quality estimate if multi-user MIMO transmission occurs. The scaling can take into account, for example, shared transmission power in case of multi-user transmission, as well as some typically small average multi-user interference portion.

The HARQ processes may then be used to compensate the possibly large initial block error rates during the first transmission (which is at least partially based on the scaled channel quality estimate). However, an exemplary embodiment of this invention provides that at some point in the retransmissions, some of the retransmissions are performed in single user transmission mode in order to guarantee (or at least improve the possibility of) the correct reception, due to the fact that interference caused by other spatially scheduled users is absent. For instance, the third and fourth retransmission in a case of a maximum number of four retransmissions may be performed in single user transmission mode.

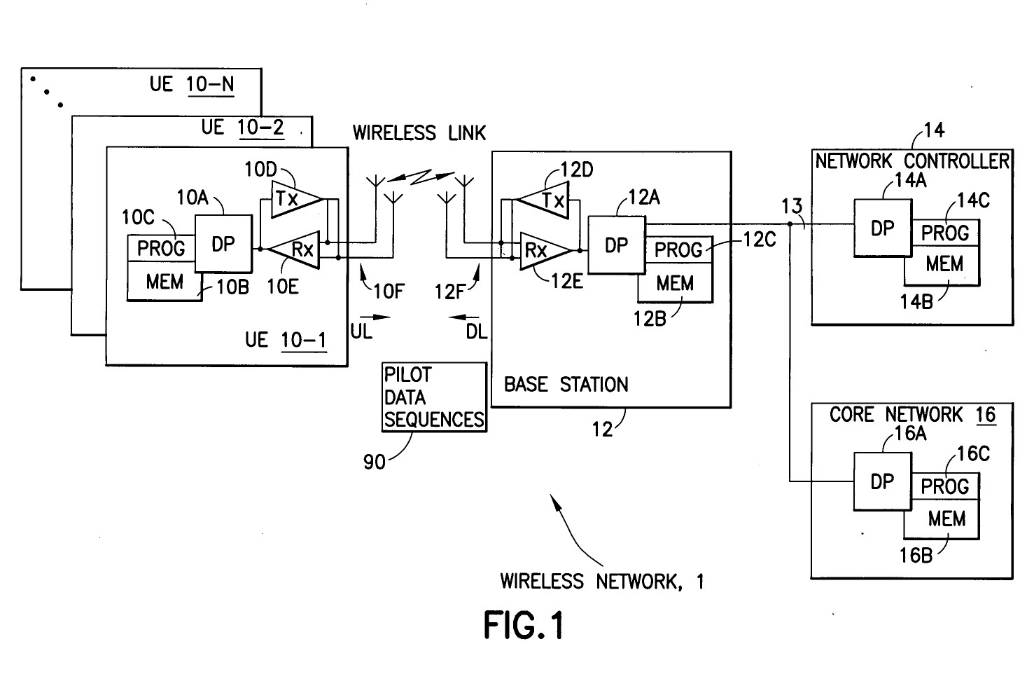

Reference is made first to FIG. 1 for illustrating a simplified block diagram of various electronic devices that are suitable for use in practicing certain exemplary embodiments of this invention. It is noted that the disclosed embodiments of this invention are not limited for use with only the wireless network 1 of FIG. 1. In FIG. 1, a wireless network 1 includes N UEs 10-1 through 10-N, a base station (e.g., a Node B or enhanced Node B, eNB) 12, a network controller (e.g., radio network controller, RNC) 14 and a core network 16. Each of the UEs 10 (which may also be referred to as “users”) includes a data processor (DP) 10A, a memory (MEM) 10B that stores a program (PROG) 10C, and a suitable radio frequency (RF) transmitter 10D, receiver 10E, and a number of antennas 10F for bidirectional wireless communication over the wireless link with the base station 12. The base station 12 also includes a DP 12A, a MEM 12B that stores a PROG 12C, and a suitable RF transmitter 12D, receiver 12E and a number of antennas 12F. The wireless link includes an uplink (UL) from a UE 10 to the base station 12, and a downlink (DL) from the base station 12 to the UE 10. Pilot (reference) sequences 90 are communicated from the base station 12 to the UEs 10 in order to determine channel quality information.

In an exemplary embodiment herein, the techniques presented herein apply at least in part to multi-user MIMO (MU-MIMO) in the downlink (DL), such as is used in third generation partnership project (3GPP) long term evolution (LTE) frequency division duplex (FDD). However, this particular type of system does not impose a limitation on the use of these embodiments.

The base station 12 is coupled via a data path 13 to the network controller 14 and the core network 16. The network controller 14 includes a DP 14A and a MEM 14B, which stores an associated PROG 14C. The core network 16 also includes DP 16A and a MEM 16B, which stores an associated PROG 16C. At least the PROGs 10C and 12C in certain embodiments are assumed to include program instructions that, when executed by the associated DP 10A or 12A, enable the associated electronic device to operate in accordance with the exemplary embodiments of this invention. At least the MEMs 10B and 12B may contain computer readable medium tangibly embodying programs of machine readable instructions executable by one or more data processors to perform operations disclosed herein.

Although the transmitters 10D and 12D and receivers 10E, 12E are shown being coupled to the same antennas 10F, 12F, respectively, this need not be the case. For example, the UE 10 may use multiple antennas 10F on the downlink but only one antenna on the uplink.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 or by the DP 12A of the base station 12, or by hardware, or by a combination of software and hardware. The MEMs 10B, 12B, 14B and 16B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A, 14A, and 16A may be of any type suitable to the local technical environment, and may include one or more of general purpose computers, special purpose computers, microprocessors, digital signal processors (DSPs) and processors based on multicore processor architectures, as non-limiting examples. It is also noted that although the DPs 10A, 12A are shown separately from the receivers 10E, 12E and transmitters 10D, 12D, the receivers 10E, 12E and/or transmitters 10D, 12D can have their own data processors. Alternatively, the receivers 10E, 12E and/or transmitters 10D, 12D can offload some of the processing to corresponding DPs 10A, 12A.

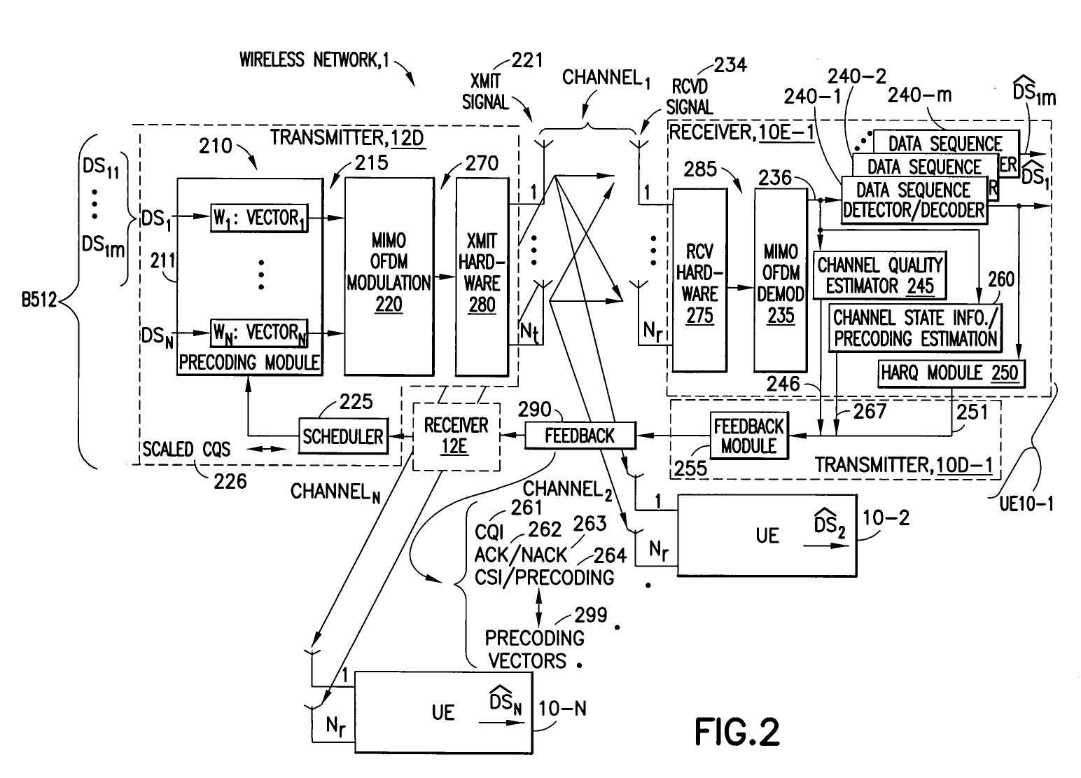

Referring now to FIG. 2, another representation is shown of the wireless network of FIG. 1. It is noted that the wireless link includes N channels per subcarrier in the example of FIGS. 1 and 2. The base station (BS) 12 includes the transmitter 12D and the receiver 12E, as in FIG. 1. The transmitter 12D has a number of data sequences DSₗ through DS_{N} for each subcarrier in an OFDMA system. A data sequence, DSᵢ, can include data from one or more packets and can be formatted as one or more symbols. Each of the data sequences, DSᵢ, is linearly precoded by a corresponding weight vector, Wᵢ, of a precoding matrix 210 to produce the linear mapping of the data sequences to the available Nₜ transmit antennas 215. The precoding matrix 210 is applied to the data sequences by the precoding module 211. A MIMO modulator (e.g., supporting orthogonal frequency division multiplexing, OFDM) 220 modulates and combines the weighted data sequences 215 of the different data sequences for each of the Nₜ transmit antennas for each active subcarrier and produces modulated data 270, which is then made suitable for transmission by transmit (XMIT) hardware 280. The transmit hardware 280 can, e.g., amplify the modulated data 270 to produce a transmit (XMIT) signal 221, which is then transmitted using the Nₜ transmit antennas. It is noted that a “matrix” is only one technique for providing precoding and is not to be construed as a limitation upon the use and practice of the exemplary embodiments. In general each subcarrier can have a different precoding matrix (e.g., instead of the vectors shown in FIG. 2). It is further noted that FIG. 2 is a simplified representation of receivers and transmitters.

In one example, each of the data sequences, DSᵢ, corresponds to one of the receivers 10E-1 through 10E-N for the UEs 10-1 through 10-N, respectively, and the data sequences are transmitted on the same physical subcarriers in multi-user MIMO transmission mode. When OFDM is used, another set of N data sequences is transmitted on another orthogonal subcarrier. Each UE 10 is assumed to include the at least one receiver 10E and transmitter 10D.

In an exemplary embodiment each receiver 10E has Nr receive antennas, receiver (RCV) hardware 275, a MIMO demodulator 235, and a data sequence detector 240. The Nᵣ receive antennas receive a received (Rcvd) signal 234, which the receiver hardware 275 operates on to produce received data 285. The demodulator 235 operates on the received data 285 to produce demodulated data 236, which the detector and decoder 240 uses to detect and decode the transmitted data (e.g., in received signal 234). Each receiver 10E also has channel state information (CSI) and preceding estimation module 260 and a channel quality estimator 245. The channel state information and precoding estimation module 260 produces an indication 267 of CSI/precoding information 264. The channel quality estimator 245 produces (e.g., based on pilot sequences 90 of FIG. 1) an indication 246 of a channel quality estimate (e.g., CQI 261). Each receiver 10E also includes a HARQ module 250, which produces an indication 251 of either an acknowledgment (ACK) indication 262, indicating correct reception of the coded data sequences, or a non-acknowledgment (negative acknowledgment or NACK) indication 263. The indications 246, 251, and 267 are coupled to the feedback module 255, in a transmitter 10D, which produces feedback 290, including in an exemplary embodiment a CQI 261, ACK 262, NACK 263 and channel state information/precoding 264. It is noted that the CQI 261 is merely one example of a channel quality estimation, and other channel quality estimations may be used, such as bit error rate or signal-to-noise ratio.

The scheduler 225 in the transmitter 12D of the base station 12 receives the feedback 290 and determines appropriate actions in response. For reception of the CQI 261, the scheduler 225 may scale the CQI 261 in order to determine the scaled CQI 226. The scheduler 225 then, using at least the scaled CQI 226, may apply link adaptation for each of the scheduled UEs. The linear precoding weights for multi-user transmission, Wₗ through W_{N}, i.e. the preceding matrix 210, are either defined by the fed-back suggested preceding vectors 299 (e.g., as part of channel state information/precoding 264) directly, or a combination of the information of all the scheduled UEs. For MU-MIMO, each of the data sequences, DSᵢ, is transmitted to the receivers 10E-i. The scheduler 225 can also cause the transmitter 12D to retransmit all those data sequences DSᵢ for which a NACK is received from any one of the receivers 10E-i. Simultaneously, the scheduler 225 can decide to transmit new data to other users, retransmit old data to some of the other users, or transmit only to user 10E-i.

In another exemplary embodiment a number of data sequences, corresponding to a number of subcarriers, are scheduled for transmission. For instance, there may be DS11 through DS1M data sequences corresponding to each UE 10. In this example, the receiver 10E would then have M data sequence detectors and decoders 240-1 through 240-M.

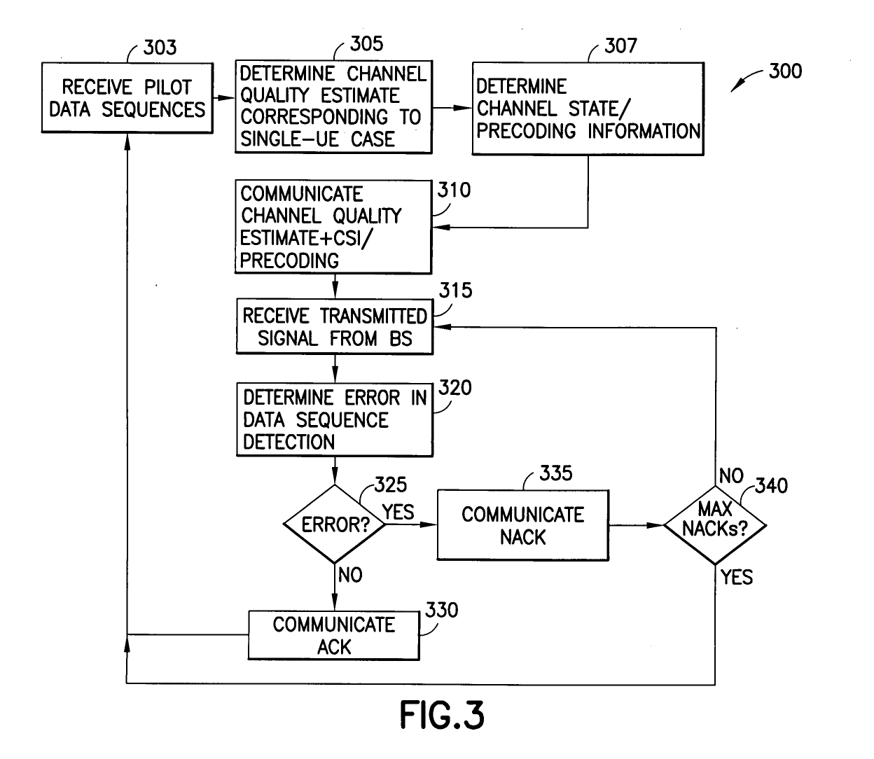

Referring now to FIG. 3, a flowchart is shown of an exemplary method 300 performed by a user equipment (a UE 10) to provide for an acknowledgment arrangement for multi-user MIMO. The method 300 begins in block 303, when pilot sequences 90 from the base station 12 are received. In block 305, a channel quality estimate, corresponding to a single-user case, is determined using the pilot sequences. The channel quality estimate in an exemplary embodiment is the CQI 261 of FIG. 2, although other estimates may be used. In block 307, the user equipment 10 determines the channel state information/precoding information (e.g., CSI/precoding information 262 of FIG. 2). In block 310, the channel quality estimate and CSI/precoding information are communicated to the base station 12. It is noted that the base station 12 preferably receives the channel quality estimates and CSI/precoding information from all the user equipment 10. In block 315, the user equipment 10 receives a transmitted signal (e.g., received signal 234, which is a version of the transmit signal 221 after the transmit signal 221 has passed through a channelᵢ of FIG. 2) from the base station 12. In block 320, it is determined if the data sequence has been correctly received (block 325=No), then an ACK is communicated in block 330 and the method 300 continues in block 305. If an error is detected (block 325=Yes) (i.e., the data sequence was not correctly received), a NACK is communicated to the base station 12 in block 335. If a maximum number of NACKs for the same data sequence has not been reached (block 340=NO), the method 300 continues in block 315. If the maximum number of NACKs for a data sequence has been reached (block 340=YES), the method continues in block 303 (i.e., the data sequence is not used).

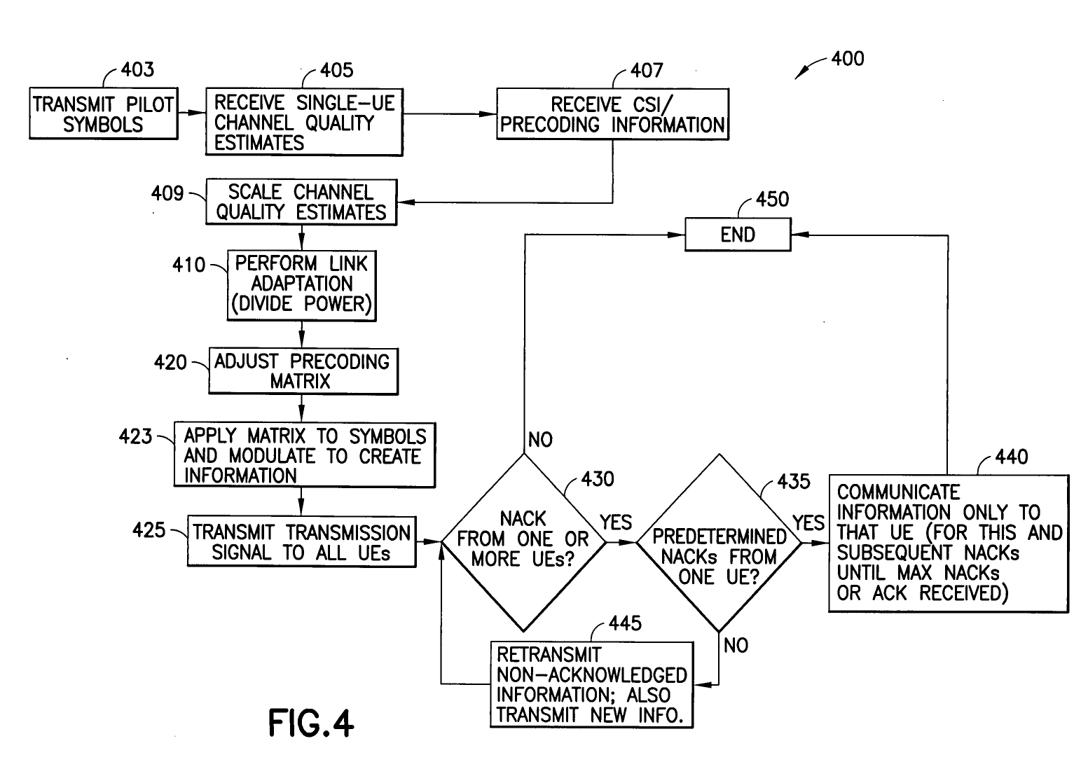

Turning now to FIG. 4, a flowchart is shown of an exemplary method 400 performed by the base station 12 to provide for an acknowledgment arrangement for multi-user MIMO. Method 400 begins in block 403, where the base station 12 transmits pilot sequences to the UEs 10. In block 405, corresponding channel quality estimates are received from all of the UEs 10. In block 407 channel state information/precoding information is received from the UEs 10. It is noted that the channel quality estimates and the channel state information/precoding information can be sent by a given user equipment 10 in a single transmission or in multiple transmissions. In block 409 the channel quality estimates are scaled. The scaling can take into account, as a non-limiting example, the shared transmission power in the case of multi-user transmissions. Furthermore, as another exemplary embodiment some possibly small average multi-user interference may be taken into account. The scaling may also depend on received ACK/NACK ratio of a user equipment 10. For instance, see “A method for Link Adaptation”, US2004/0100911A1, May 27, 2004, by inventors: Raymond Kwan, Klaus Ingemar Pedersen, Preben Mogensen and Troels Kolding, the disclosure of which is hereby incorporated by reference in its entirety. In block 410, using at least the scaled channel quality estimates, link adaptation is performed. Block 410 may also include dividing the power used for transmission to each of the user equipment 10. In block 420 the preceding matrix is adjusted based at least in part on the channel state information/precoding information. In block 423 the precoding matrix is applied to the data sequences/streams (e.g., a set of information), and the result is modulated and the modulated signals intended for different UEs are combined in order to create the total downlink transmission signal (e.g., transmit signal 221). In block 425, the transmission signal (e.g., data sequences DS, as encoded, precoded, if preceding is used, and combined) is transmitted to all UEs 10. In block 430 it is determined if a NACK is received from any of the UEs. If so (block 430=YES), it is determined in block 435 if the predetermined number of NACKs has been received from one of the UEs 10. If not (block 435=No), the not-acknowledged part of the information is retransmitted (block 445) to those UEs that transmitted NACKs, and the method 400 continues in block 430. In parallel to the retransmissions, new data sequences may be scheduled (e.g., to the UEs 10 that did not transmit NACKs and instead transmitted ACKs). If a predetermined number of NACKs have been received from a particular UE 10 (block 435=YES), then the data sequence(s) for the particular UE, which has reached the predetermined threshold number of NACKs, is communicated in block 440 to only that UE 10. For example, the data sequence to be retransmitted for the particular UE 10 is modulated and transmitted alone on the allocated subcarriers. No information for the other N-1 (in the examples of FIGS. 1 and 2) UEs 10 is transmitted on the same physical resources (e.g., subcarriers in the case of an OFDM system). This transmission is performed for the current NACK and subsequent NACKs, up until the maximum number of NACKs is received from this one particular UE 10 (or an ACK from this one particular UE 10 is received). For example, if the predetermined number of NACKs is three and the maximum number of NACKs is five, then when the third NACK is received, subsequent transmissions to this UE are made as a single-stream, single-user transmission (no spatially multiplexed data for any other UE 10) until either the fifth NACK is received, or an ACK is received, from this one particular UE 10. At this point, no additional transmissions are scheduled for the data sequence(s). The method 400 ends in block 450, if no NACKs are received (block 430=NO), or block 440 is performed.

Note that the threshold NACK value of three and the maximum NACK value of five are provided merely as examples, as other values may be used as well. Furthermore, the particular value(s) used for one or both of these parameters may be fixed, or may be made variable and possibly adaptive depending on, for example, system operating conditions, the amount of noise present, the number of potentially interfering users, the distance of the UE 10 from the BS 12 and/or other criteria.

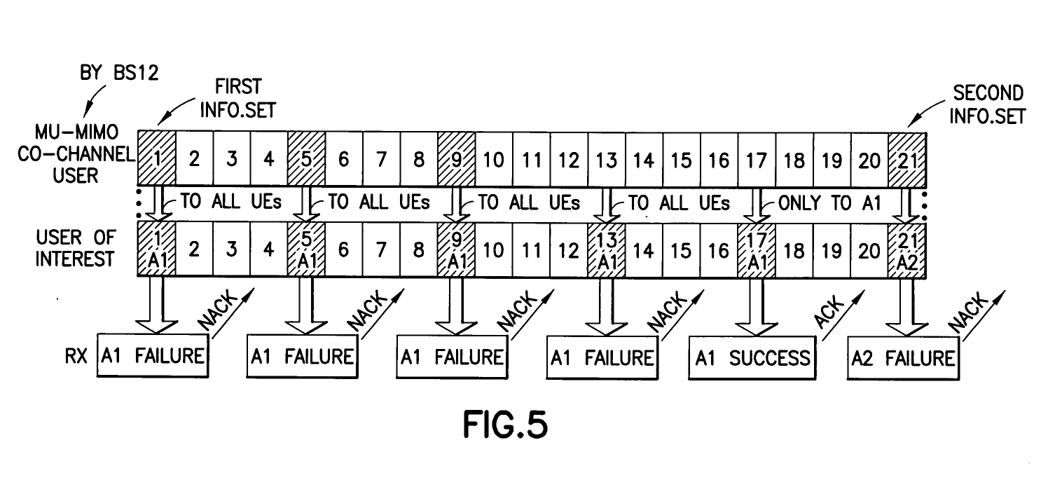

FIG. 5 is an exemplary diagram of acknowledgment operation for multi-user MIMO. In this example, the MU-MIMO co-channel user is shown, as is a user of interest (i.e., a certain UE 10). In this case there are 21 transmission periods. In the first period, the base station 12 transmits a first set of information for all UEs, but UE of interest 10 receives the information data block A1 and detects an error (e.g., “failure”). Periods 2-4 are reserved for scheduling to other users or other HARQ processes of the users. The UE 10 then communicates the NACK to the base station 12. The base station 12 responds by retransmitting (in period 5) the information A1 to the UE of interest and, in parallel, transmits data to the MU-MIMO co-channel user (i.e., a retransmission or new data transmission). The UE of interest again detects an error in decoding the data sequence A1, and sends a NACK. This process continues until the UE of interest sends, for example, three NACKs, at which point the base station 12 transmits only to the UE (of interest) the data sequence A1 on the physical resources, but not to any other MU-MIMO co-channel user. This fourth transmission finally results in no errors (e.g., “success”) in this example. The UE 10 correspondingly responds with an ACK. The base station 12 then sends a new data sequence A2 for the user of interest and also a MU-MIMO transmission to a co-channel user.

The embodiments of this invention may be implemented by computer software executable by a data processor, or by hardware circuitry, or by a combination of software and hardware circuitry. Further in this regard it should be noted that the various blocks of the logic flow diagrams of FIGS. 3 and 4 might represent program steps, or interconnected logic circuits, blocks and functions, or a combination of program steps and logic circuits, blocks and functions for performing the specified tasks. It is further noted that embodiments herein may be implemented using a computer-readable medium comprising program instructions tangibly embodied thereon, where execution of the program instructions result in operations discussed previously. The computer-readable medium may be a semiconductor-based memory, a compact disk (CD), a digital versatile disk (DVD), a memory stick, a hard drive, or any other data storage. Embodiments of the inventions may be practiced in various components such as integrated circuit modules.

In an exemplary embodiment, a method is disclosed that includes modulating a plurality of data sequences, where the plurality of data sequences correspond to a plurality of user equipment. The method includes transmitting, using a plurality of antennas, the modulated data sequences to the plurality of user equipment. The method includes, in response to a predetermined number of NACKs being received from a particular one of the user equipment, retransmitting using the plurality of antennas the data sequences corresponding only to the particular user equipment.

In a further exemplary embodiment, the method includes, in response to a NACK being received from at least one of the user equipment, where a number of NACKs received from each (e.g., all) of the user equipment is less than the predetermined number of NACKs, performing retransmission of non-acknowledged data sequences and a new transmission of new data to user equipment that did not send a NACK (e.g., that sent an ACK). The retransmission and new transmission is performed in multi-user MIMO fashion (e.g., in a single transmission using the antennas Nt). In an additional exemplary embodiment, one data sequence corresponds to each user equipment. In a further exemplary embodiment, there are multiple data sequences corresponding to at least one of the user equipment.

In other exemplary embodiments, the method includes receiving channel quality estimates from the user equipment, each of the channel quality estimates corresponding to channel conditions for a single-user, single-stream transmission to a corresponding one of the user equipment. The channel quality estimates can be CQI or other estimates. The method can include performing link adaptation using at least the channel quality estimates. In a further exemplary embodiment, the method includes receiving channel state information, determining a preceding matrix based at least on the channel state information, and applying the precoding matrix to the plurality of data sequences prior to modulation. In additional embodiments, the preceding matrix includes a number of vectors, each vector corresponding to a data sequence associated with corresponding user equipment. Further, the vectors can themselves be matrices. In other embodiments, modulating includes coding and combining the data sequences to create a transmit signal that is transmitted.

In other exemplary embodiments, retransmitting using the plurality of antennas the data sequences corresponding only to the particular user equipment is performed for each NACK received from the particular user equipment until a maximum number of NACKs has been received, wherein the retransmissions to the particular user equipment are no longer performed.

In a further exemplary embodiment, a network node is disclosed that includes a transmitter and a plurality of antennas. The transmitter is configured to modulate a plurality of data sequences, where the plurality of data sequences correspond to a plurality of user equipment. The transmitter is configured to transmit, using the plurality of antennas, the modulated data sequences to the plurality of user equipment. The transmitter is configured, in response to a predetermined number of NACKs being received from a particular one of the user equipment, to retransmit using the plurality of antennas the data sequences corresponding only to the particular user equipment. In a further exemplary embodiment, the transmitter is implemented as at least one integrated circuit module.

In an additional exemplary embodiment, the transmitter includes a modulator that modulates the data sequences to create the modulated data sequences. In a further exemplary embodiment, the network node further includes a receiver configured to receive channel quality estimates from the user equipment, each of the channel quality estimates corresponding to channel conditions for a single-user transmission to a corresponding one of the user equipment. The transmitter further includes a scheduler configured to scale the channel quality estimates and to perform link adaptation and to divide the power used for transmission to each of the user equipment. In a further embodiment, the receiver is configured to receive channel state information and the scheduler uses the channel state information to determine a precoding matrix, and the transmitter further comprises a preceding module applied to data sequences corresponding to the plurality of user equipment, the application of the preceding matrix creating output that is modulated by the modulator.

In an additional exemplary embodiment, a computer-readable medium is disclosed that includes program instructions tangibly embodied thereon, where execution of the program instructions result in operations. The operations include modulating a plurality of data sequences, where the plurality of data sequences correspond to a plurality of user equipment. The method includes transmitting, using a plurality of antennas, the modulated data sequences to the plurality of user equipment. The method includes, in response to a predetermined number of NACKs being received from a particular one of the user equipment, retransmitting using the plurality of antennas the data sequences corresponding only to the particular user equipment.

In yet another exemplary embodiment, a network node is disclosed that includes a plurality of antenna means. The network node includes a means for modulating a plurality of data sequences, where the plurality of data sequences correspond to a plurality of user equipment. The network node includes a means for transmitting, using the plurality of antennas, the modulated data sequences to the plurality of user equipment. The network node includes means for, in response to a predetermined number of NACKs being received from a particular one of the user equipment, transmitting using the plurality of antennas the data sequences corresponding only to the particular user equipment.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. For instance, in an exemplary embodiment, the techniques herein can be applied to a WCDMA (wide-band code division multiple access) system by replacing the OFDMA modulation by CDMA specific spreading sequences. In another exemplary embodiment, the techniques presented herein may be applied to a time division duplexing system (TDD), e.g., by assuming that the channel state and channel quality information may be at least partially solved from an uplink training signal. All such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
modulating a plurality of data sequences, where the plurality of data sequences correspond to a plurality of user equipment;
transmitting, using a plurality of antennas, the modulated data sequences to the plurality of user equipment; and
in response to a predetermined number of non-acknowledgment indications being received from a particular one of the user equipment, retransmitting using the plurality of antennas a non-acknowledged data sequence corresponding only to the particular user equipment.

2. The method of claim 1, further comprising in response to a non-acknowledgment indication being received from at least one of the user equipment, where a total number of non-acknowledgment indications received from each individual one of the plurality of user equipment is less than the predetermined number of non-acknowledgment indications, performing retransmission of a non-acknowledged data sequence and a first transmission of a new data sequence to another user equipment that did not send a non-acknowledgment indication.

3. The method of claim 2, where the retransmission and the first transmission are performed in a multi-user multiple input/multiple output manner.

4. The method of claim 1, where one data sequence corresponds to each individual one of the plurality of user equipment.

5. The method of claim 1, where multiple data sequences correspond to at least one of the plurality of user equipment.

6. The method of claim 1, further comprising receiving channel quality estimates from the plurality of user equipment, each of the channel quality estimates corresponding to channel conditions for a single-user, single-stream transmission to a corresponding one of the user equipment.

7. The method of claim 1, further comprising receiving channel state information, determining a preceding matrix based at least on the channel state information, and applying the preceding matrix to the plurality of data sequences prior to modulation.

8. The method of claim 7, where the precoding matrix includes a number of vectors, each vector corresponding to a data sequence associated with corresponding user equipment.

9. The method of claim 1, where retransmitting is performed for each non-acknowledgment indication received from the particular user equipment only until a maximum number of non-acknowledgment indications has been received.

10. An apparatus, comprising:
a modulator configured to modulate a plurality of data sequences, where individual ones of the plurality of data sequences correspond to individual ones of a plurality of user equipment;
a transmitter configured for operation with a plurality of antennas and further configured to simultaneously transmit the modulated data sequences to the plurality of user equipment;
a receiver configured to receive one of an acknowledgment or a non-acknowledgment indication from individual ones of the plurality of user equipment indicating success or failure, respectively, of an individual one of the user equipment correctly receiving a corresponding transmitted data sequence; and
a controller, configured to respond to a predetermined number of non-acknowledgment indications being received from a particular one of the user equipment for a particular one of the transmitted data sequences, to retransmit the corresponding data sequence only to the particular user equipment.

11. The apparatus of claim 10, where said receiver is further configured to receive channel quality estimates from the plurality of user equipment, each of the channel quality estimates corresponding to channel conditions for a single-user transmission to a corresponding one of the user equipment.

12. The apparatus of claim 11, said controller further configured to scale the channel quality estimates, to perform link adaptation and to divide the power used for transmission to each of the user equipment.

13. The apparatus of claim 10, where said receiver is further configured to receive channel state information and where said controller is further configured to use the channel state information to determine a preceding matrix and to precode data sequences corresponding to the plurality of user equipment using the preceding matrix prior to the data sequences being applied to said modulator.

14. The apparatus of claim 10, embodied at least partially in at least one integrated circuit.

15. A computer-readable medium having program instructions tangibly embodied thereon, where execution of the program instructions result in operations that include:
modulating a plurality of data sequences, where the plurality of data sequences correspond to a plurality of user equipment;
transmitting, using a plurality of antennas, the modulated data sequences to the plurality of user equipment; and
n response to a predetermined number of non-acknowledgment indications being received from a particular one of the user equipment, retransmitting using the plurality of antennas a non-acknowledged data sequence corresponding only to the particular user equipment.

16. The computer-readable medium of claim 15, the operations further comprising, in response to a non-acknowledgment indication being received from at least one of the user equipment, where a total number of non-acknowledgment indications received from each individual one of the plurality of user equipment is less than the predetermined number of non-acknowledgment indications, performing retransmission of a non-acknowledged data sequence and a first transmission of a new data sequence to another user equipment that did not send a non-acknowledgment indication.

17. The computer-readable medium of claim 16, where the retransmission and the first transmission are performed in a multi-user multiple input/multiple output manner.

18. The computer-readable medium of claim 15, where one data sequence corresponds to each individual one of the plurality of user equipment.

19. The computer-readable medium of claim 15, where multiple data sequences correspond to at least one of the plurality of user equipment.

20. The computer-readable medium of claim 15, the operations further comprising receiving channel quality estimates from the plurality of user equipment, each of the channel quality estimates corresponding to channel conditions for a single-user, single-stream transmission to a corresponding one of the user equipment.

21. The computer-readable medium of claim 15, the operations further comprising receiving channel state information, determining a precoding matrix based at least on the channel state information, and applying the precoding matrix to the plurality of data sequences prior to modulation.

22. The computer-readable medium of claim 21, where the precoding matrix includes a number of vectors, each vector corresponding to a data sequence associated with corresponding user equipment.

23. The computer-readable medium of claim 15, where retransmitting is executed for each non-acknowledgment indication received from the particular user equipment only until a maximum number of non-acknowledgment indications has been received.

24. The computer-readable medium of claim 15, embodied in a base station.

25. An apparatus, comprising:
means for modulating a plurality of data sequences, where the plurality of data sequences correspond to a plurality of user equipment;
means for transmitting in a multi-user multiple input/multiple output manner the modulated data sequences to the plurality of user equipment; and
means for retransmitting in the multi-user multiple input/multiple output manner a corresponding one of the data sequences to a particular user equipment from which a non-acknowledgment indication is received, said retransmitting means is configured to respond to a predetermined number of non-acknowledgment indications being received from a particular one of the user equipment for retransmitting in a single stream, single user manner a non-acknowledged corresponding one of the data sequences only to the particular user equipment, where the predetermined number of non-acknowledgment indications is less than a maximum number, and where if the maximum number of non-acknowledgment indications is received said retransmitting means terminates retransmission of the non-acknowledged corresponding one of the data sequences.

26. The apparatus of claim 25, said transmitting means cooperating with said retransmitting means, when the number of non-acknowledgment indications received is less than the predetermined number, so as to retransmit the non-acknowledged corresponding one of the data sequences while transmitting a first transmission of a new data sequence to another user equipment.

27. The apparatus of claim 25, embodied in a base station.

28. The apparatus of claim 25, embodied at least partially in at least one integrated circuit.

29. An apparatus, comprising:
a modulator configured to modulate a plurality of data sequences, where the plurality of data sequences correspond to a plurality of user equipment; and
a transmitter configured with a controller to transmit in a multi-user multiple input/multiple output manner the modulated data sequences to the plurality of user equipment, said transmitter further configured with said controller to retransmit in the multi-user multiple input/multiple output manner a corresponding one of the data sequences to a particular user equipment from which a non-acknowledgment indication is received, said controller configured to respond to a predetermined number of non-acknowledgment indications being received from a particular one of the user equipment to operate said transmitter to retransmit in a single stream, single user manner a non-acknowledged corresponding one of the data sequences only to the particular user equipment.

30. The apparatus of claim 29, where the predetermined number of non-acknowledgment indications is less than a maximum number, and where if the maximum number of non-acknowledgment indications is received said controller terminates retransmission of the non-acknowledged corresponding one of the data sequences.

31. The apparatus of claim 29, said controller being further configured, when the number of non-acknowledgment indications received is less than the predetermined number, to retransmit the non-acknowledged corresponding one of the data sequences while transmitting a first transmission of a new data sequence to another user equipment.

32. The apparatus of claim 29, embodied in a base station.

33. The apparatus of claim 29, embodied at least partially in at least one integrated circuit.
